(19) United States
(12) Patent Application Publication
(10) Pub. No.: US 2002/0163690 A1
(43) Pub. Date: Nov. 7, 2002

(54) Flexible and low cost wavelength management for optical networking

(76) Inventor: Dan Dan Yang, Ottawa (CA)

Correspondence Address: Cassan MacLean, Suite 401, 80 Aberdeen Street, Ottawa, ON, K1S 5R5, CA

(21) Appl. No.: 10/184,884

(22) Filed: Jul. 1, 2002

Related U.S. Application Data
(63) Continuation-in-part of application No. 09/781,254, filed on Feb. 13, 2001.

(51) Int. Cl. H04J 14/02

(52) U.S. Cl. 359/124; 359/127

(57) ABSTRACT

A method and devices for individually controlling the signal strength of single or multiple optical channels. A controller module monitors the signal strength of channels and amplifies those that need amplifying while attenuating those that are too strong using the same Erbium doped fiber amplifier. A controllable compensation module receives at least one channel and, when required, can either amplify or attenuate the signal strength of the channels. The module can be constructed out of a single fiber with an associated pump laser. If the laser provides insufficient pumping power, the fiber acts as an attenuator. If the laser provides a higher level of pump power, the fiber acts as an amplifier.

This application is a continuation-in-part application of U.S. application Ser. No. 09/781,254, filed Feb. 13, 2001.

### FIELD OF THE INVENTION

The present invention relates to optical network wavelength management and configuration and, more specifically, to a programmable optical processor.

### BACKGROUND TO THE INVENTION

The unprecedented growth of the Internet, E-commerce, private networks, high resolution digital video, and voice over IP is dramatically changing the demand for high speed broadband networks. Dense Wavelength Division Multiplexing (DWDM) technology has been deployed and widely adopted, not only for long-haul backbone networks, but also for the metropolitan network market. The fundamental idea of DWDM technology is to simultaneously transmit multiple wavelengths over the same fiber. Systems based on DWDM often have optical amplifiers, especially Erbium doped fiber based amplifiers, to compensate for transmission losses incurred during transmission. However, theses optical amplifiers often cannot amplify different wavelength channels equally, resulting in signal strength differences among channels.

The evolution of optical networks has also brought a new kind, of system topology, where an individual or a sub-group of several wavelength channels, among the whole group, may be switched, added, or dropped at a certain central office (referred as optical nodes). This may result in different transmission paths with individual or sub-groups of several wavelength channels transmitting through different network elements. Both result in different transmission losses (by fiber and/or devices) for different channels or sub-groups of channels.

Whether due to amplification, and/or to differences in transmission loss, when these channels reach a receiver, they do not have the same signal strength. The difference in signal strength can result in a situation where some channels overload the receiver because of too much power while others cause detection errors because of a weak incoming signal.

As an example, if group A channels are being sent to receiver A1 and group B channels are being sent to receiver B1 arid both group A and B channels transit through the sane amplifier, problems may occur. If receiver A1 is much closer to the amplifier than receiver B1, then group A signals may arrive with more power at receiver A1 than group B signals when they arrive at receiver B1. This is primarily because both group A and B share the same amplification medium and the amplifier cannot adjust its amplification of certain channels or groups individually traveling on the same fiber.

Currently, two methods exist which can compensate for such problems. The first is termed the pre or post tilting method (also called padding)—each channel is provided with a tilt either before the channel reaches the receiver or after the channel has left the transmitter. This method implies the use of separate optical attenuators for each channel. These attenuators can be set such that channels with a stronger signal strength are attenuated or given more loss than channels with a weaker signal strength. The signal strengths of the channels are thus equalized by the time the channels reach the receiver.

The second method involves gain flattening of optical amplifiers. Gain flattening filters are used with an optical amplifier so that stronger channels (channels with a higher signal strength) have their gain or amplification curtailed to equalize the signal strength among all the channels.

Network designers currently choose one or both of the two above methods. Both of these methods rely on a single concept—the attenuation of the signal strength of stronger channels. Unfortunately, attenuation can prove to be costly. The pre-tilt method necessitates a large of attenuators. Each attenuator can be costly arid, for a typical 40 channel system with one attenuator assigned to each channel, the cost rises accordingly for the whole system. For the gain flattening approach, the cost can also be correspondingly high. Not only does the system designer ave to factor in the cost of the amplifier but also the complexity of the structure, waste of pump power, more components and lower manufacturing yield.

While there are gain flattened amplifiers now available, the physics of Erbium doped fiber amplifiers renders gain flattening quite difficult, especially to the level that an optical network requires. This difficulty causes a low yield rate when manufacturing gain flattened fiber amplifiers.

Also, when using gain flattened fiber (one providing more power) is required. This is because more pump power is required to compensate for the decreased amplification caused by the attenuation through the gain flattening filter. For the above reasons, gain flattened amplifiers, even passively flattened ones, are about 30-50% more expensive than non-gain flattened amplifiers for the same amplification factor.

There is therefore a need for a new approach which allows controllable amplification and/or attenuation of selected channels. Such a new method, and the apparatus which implements it, must necessarily overcome the problems associated with the known techniques as outlined above.

### SUMMARY OF THE INVENTION

The present invention overcomes the problems discussed above by providing a method and devices for individually controlling the signal strength of single or multiple optical channels. A controller module monitors the signal strength of channels and amplifies those that need amplifying while attenuating those that are too strong using the same Erbium doped fiber amplifier. A controllable compensation module receives at least one channel and, when required, can either amplify or attenuate the signal strength of the channels. The module can be constructed out of a single fiber with an associated pump laser. If the laser provides insufficient pumping power, the fiber acts as an attenuator. If the laser provides a higher level of pump power, the fiber acts as an amplifier.

By independently controlling each compensation module, the signal strength of each channel or group of channels can be independently increased or decreased. This provides a level of control for each channel or channel group that is unprecedented. Because of this, costly pre-tilt and/or gain flattening methods of channel equalization are avoided.

To control the signal strength of multiple channels, a band or range of adjacent optical channels is chosen and isolated from the other optical channels. This band of optical channels is then attenuated or amplified as a group.

In a first aspect, the present invention provides a method of controlling a selected group of adjacent optical channels, the method comprising the steps of:

a) selecting a range of adjacent optical channels for inclusion into said group;

b) isolating said selected range of adjacent optical channels from other optical channels;

c) determining an amount by which a signal strength of said selected range of adjacent optical channels is to be changed; and

d) changing said signal strength for said selected range of adjacent optical channels by said amount.

In a second aspect, the present invention provides a system for controlling a signal strength of a selected group of adjacent optical channels, the system comprising:

isolation means for isolating said adjacent optical channels from other optical channels;

means for changing said signal strength of said adjacent optical channels;

control means for controlling said means for changing said signal strength, wherein

said isolation means routes said adjacent optical channels to said means for changing said signal strength after isolating said adjacent optical channels, and

said control means sends control signals to said means for changing said signal strength to control an amount by which said signal strength of said adjacent optical channels is changed.

In a third aspect the present invention provides a method of controlling a selected group of adjacent optical channels, the method comprising the steps of:

a) selecting a range of adjacent optical channels for inclusion into said group;

b) isolating said selected range of adjacent optical channels from other optical channels;

c) determining an amount by which a signal strength of said selected range of adjacent optical channels is to be changed; and

d) changing said signal strength for said selected range of adjacent optical channels by said amount such that said signal strength is substantially similar to corresponding signal strengths of other optical channels.

### BRIEF DESCRIPTION OF THE DRAWINGS

A better understanding of the invention will be obtained by considering the detailed description below, with reference to the following drawings in which:

FIG. 1 is a block diagram of a multichannel optical fiber transport system according to the prior art;

FIG. 2 is a block diagram of a multichannel transport system according to one aspect of the invention;

FIG. 3 is a block diagram of a programmable optical processor according to another aspect of the invention;

FIG. 4 is a block diagram of a controllable compensation module according to another aspect of the invention;

FIG. 5 is a graph showing attenuation and amplification in an optical fiber dependent on pump laser power;

FIG. 6 is a flow chart of the logic followed by the controller of the programable optical processor;

FIG. 7 is a block diagram of an expanded programable optical processor;

FIG. 8 is an illustration of an optical spectrum which has been grouped or “digitized” for better control as used in the invention; and

FIG. 9 is a block diagram of a system which allows for the amplification/attenuation of bands or ranges of optical channels.

### DETAILED DESCRIPTION OF PREFERRED EMBODIMENT

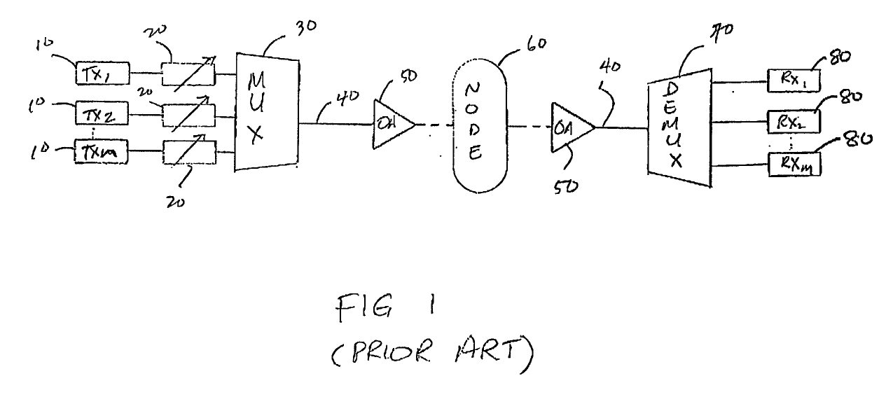

Referring to FIG. 1, a multi-channel transport system according to the prior art is illustrated. Transmitters 10 feed variable attenuators 20 which in turn feed a multiplexer 30. The multiplexer 30 multiplexes the channel from transmitters into an optical path such as an optical fiber line 40, which feeds into one or more optical amplifiers 50. These optical amplifiers 50 are gain flattened to provide equal gain to all the channels on the single line 40. Between the optical amplifiers 50 may be multiple nodes 60, only one being illustrated in FIG. 1. These nodes may add, drop, or switch channels from the single optical line 40. The gain equalized channels are then fed into a demultiplexer 70 where the channels are demultiplexed to be further sent to multiple receivers 80.

It should be noted that while FIG. 1 places the adjustable attenuators 20 between the transmitters 10 and the multiplexer 30, these attenuators may also be placed between the demultiplexer 70 and the receiver 80.

The system of FIG. 1 equalizes the signal strength of the channels where possible whether within or without the optical amplifiers by attenuating the stronger channels using attenuators 20. As noted above, this approach leads to costly equipment. It should also be noted that the system of FIG. 1 cannot control the signal strength of individual channels between the multiplexer 30 and the demultiplexer 70. Any channels added by node 60 will have an uncontrolled signal strength compared to the signal strength of the pre-existing channels on the path 40.

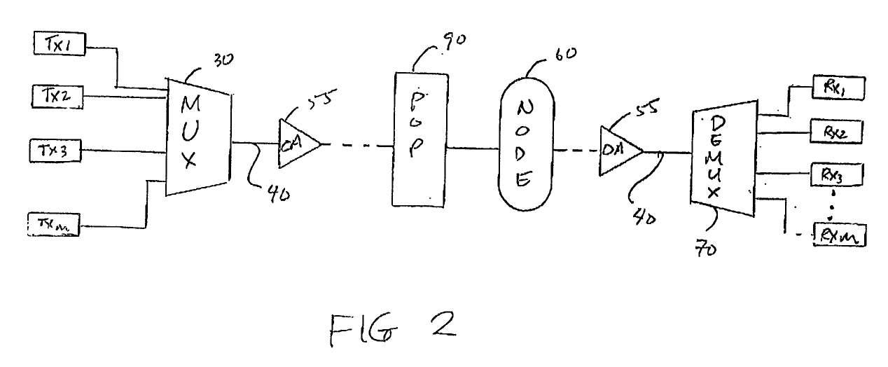

FIG. 2 illustrates a system according to one aspect of the invention. With similar numbers referencing similar components, the system of FIG. 2 adds an extra component—a programmable optical processor (POP) 90. It should be noted that the optical amplifiers 55 in FIG. 2 are low cost non gain-flattened optical amplifiers. The programmable optical processor 90 uses software to control the signal strength of the channels on the single optical link 40 according to any criteria desired such as receiver requirements or other network conditions.

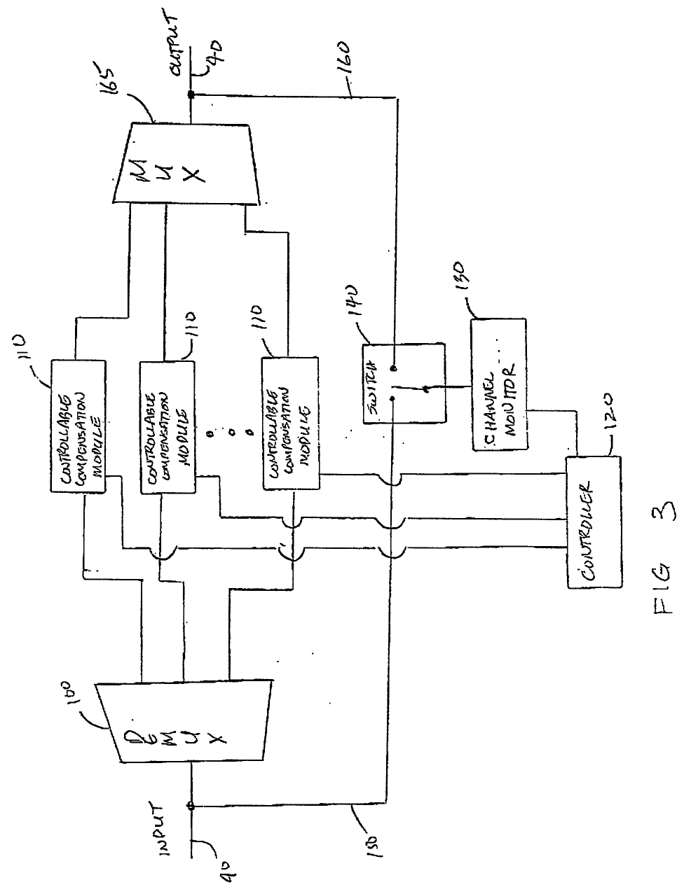

Referring to FIG. 3, a configuration for the POP 90 is illustrated. The single optical line 40 is fed into a demultiplexer 100 which demultiplexes the compound multiple wavelength optical signal into its multiple components or channels. These channels are then fed into a controllable compensation module 110. These modules are coupled to and controlled by a controller 120. The controller 120 is, in turn, coupled to a channel. monitor 130 which, using an optical switch 140 is able to determine the signal strength of each channel through optical taps 150 and 160.

The output of the modules 110 are then transmitted to a multiplexer 165 which multiplexes them into another single optical line 40. However, the input signal to demultiplexer 100 is generally different from the output signal of multiplexer 165 in that the output signal may now have different channel power levels.

The working of this system is as follows: the channel monitor determines the input signal strength of each channel through switch 140 and tap 150. The results are then sent to the controller 130. Based on this determination and predetermined criteria programmed into the controller 120, the controller 120 the determines whether a given channel or group of channels need to have its signal strength modified, attenuated, or left unchanged.

If the channel or group of channels need signal strength attenuation, the controller 120 commands the relevant compensation module to attenuate the incoming channel(s). If, on the other hand, signal strength amplification is needed, then the controller 120 commands the compensation module 110 to amplify the incoming channel(s). After this, the signals are remultiplexed by the multiplexer 165.

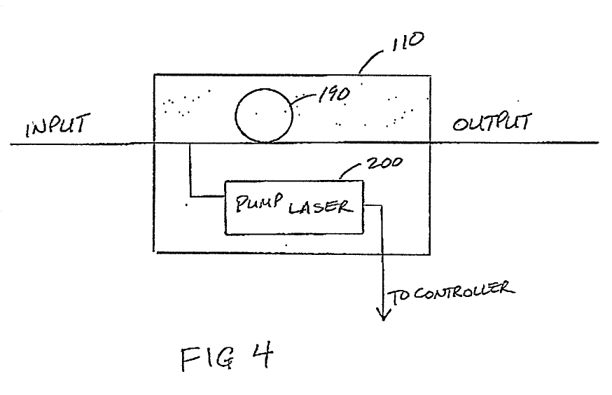

It should be clear from the above that the compensation modules 110 are each capable of either amplifying or attenuating an incoming signal or channel. It should also be clear that the levels of attenuation or amplification are controllable by the controller 120. FIG. 4 illustrates one configuration for the compensation module. The module 110 consists of an optical fiber 190 of predetermined length along with a pump laser 200. The pump laser 200 is controlled by the controller 120 and the fiber 190 receives the optical signal. The fiber 190 can be a very short piece of Erbium doped fiber or waveguide and the pump laser can be a diode laser. This short piece of Erbium doped fiber/waveguide exhibits attenuation when the injected pump laser power is insufficient to compensate for the absorption of the signal by the fiber/waveguide. However, where the pump laser power is sufficient to overcome this absorption, then the fiber/waveguide amplifies the signal. A detailed calculation using conventional erbium fiber simulation tools can predict the required erbium fiber length. Typically, it is straightforward to obtain an attenuation from 10 dB to 0 dB and gain from 0 dB to 10 dB. Such an erbium fiber based device is used to compensate for the discrepancies among the channels as described herein. For this purpose, such a relatively small gain is enough.

It should be noted that the optical signal may contain more than one channel and that the module 110 is either attenuating or amplifying the signal. By setting the amplification or the attenuation to zero, the module may nominally be amplifying or attenuating but is not changing the signal strength of a channel.

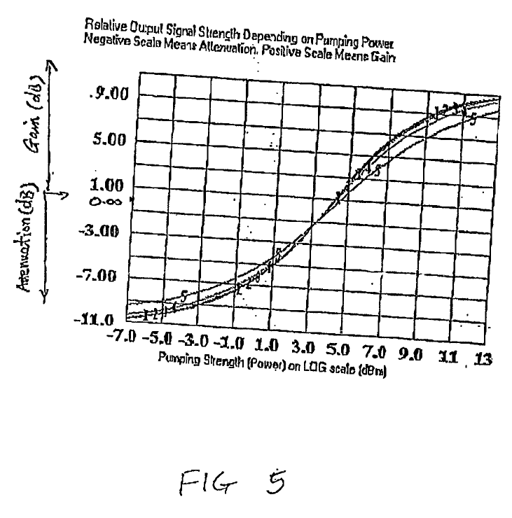

FIG. 5 illustrates a graph showing the attenuation/amplification discussed above for a piece of Erbium doped fiber or waveguide. With the horizontal axis as the pumping power or strength from a pump laser and the vertical axis as the gain/attenuation, it can be seen that below zero gain pumping power the attenuation (negative gain) increases. Concomitantly, as the pump power, increases above the zero gain point the gain increases as well.

While the above example uses an Erbium doped fiber or waveguide, the optical medium in the module as illustrated in FIG. 4 can be any optical medium which absorbs optical power when an insufficient amount of pump optical power (usually from a pump laser) is injected into the medium. Such a medium attenuates an input signal when the pump power is insufficient. However, this medium must also amplify the input optical signal when the pump power provided by the pump laser is sufficient to overcome the medium's optical signal absorption. Needless to say, the pump laser 200 (FIG. 4) must be capable of outputting enough pump power to overcome this absorption. Other than an Erbium doped fiber/waveguide, it has been found that an InGaAS (Indium Gallium Arsenide) based semiconductor waveguide, such as that used for semiconductor optical amplifiers, can also be used.

Regarding the channel monitor 130 (FIG. 3), this device is used to determine the intensity of both the incoming and the outgoing optical channels. The monitor 130 can be either a diffraction grating or scanning filter, as long as each channel's wavelength and intensity can be directly detected. In one configuration, the monitor can be a diffraction grating combined with a CCD (charge coupled device) detector. In another configuration, the monitor 130 can be a scanning filter which scans the input or output signal channel by channel with each channel's wavelength information being calculated using a comparison of the signal with an initial calibration.

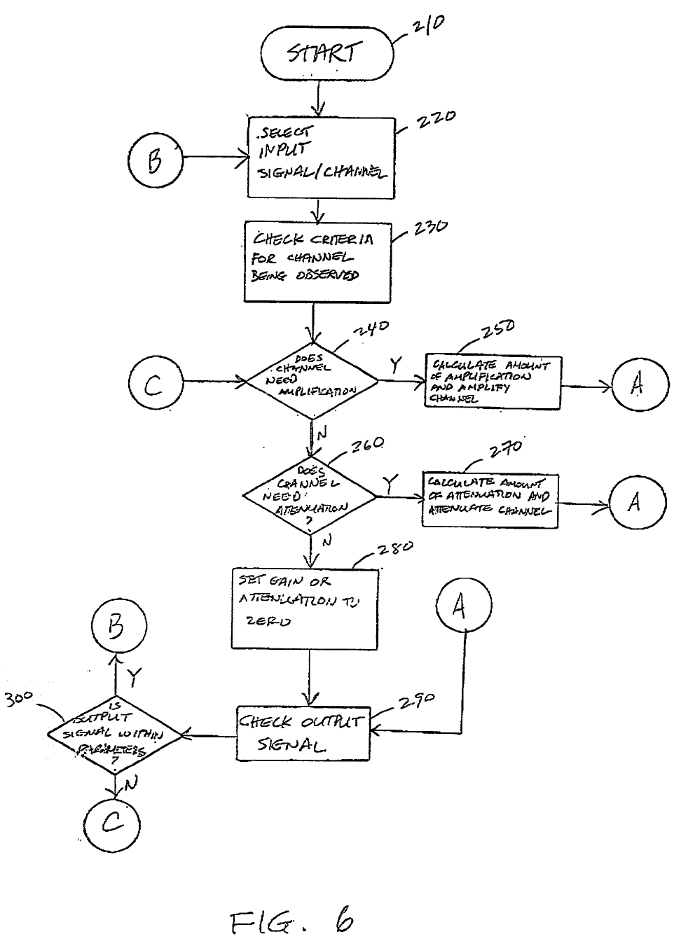

The logic flow of the software running the controller 120 is illustrated in the flowchart of FIG. 6.

As can be seen from FIG. 6, the process begins at step 210. The channel monitor then detects the input signal or channel at step 220. This detection involves determining the signal strength of the chosen signal/channel. (Thus, if there are 10 channels multiplexed into one compound signal, the monitor can choose only one of the 10.) Step 230 is that of checking the predetermined, criteria for the requirement for the particular signal being examined. As an example, if the end receiver can only take a certain signal strength, then this can be the basis for the upper limit of a predetermined range of an acceptable signal strength. On the other hand, if too high data hit error rate (BER) is caused by a signal strength below a certain threshold, then this threshold can form the lower limit of the same predetermined range. Thus, the range is for an acceptable signal strength for a channel. If the channel's signal strength is above the upper limit, then the channel must be attenuated.

As another example, if a channel is added to the system for inclusion in the output compound signal, this channel may have too low a signal strength. Thus, such a channel would need to be amplified based not only on the detected signal strength but also on the requirements of the system. Alternatively, if a channel is to be routed to a destination different from that of the other channels, this channel may need to be attenuated or amplified depending on whether its destination is physically further or nearer than the other channels' destination. If further, then the channel may need to be boosted (amplified) to compensate for expected signal degradation. If nearer, then the channel may need to be attenuated to prevent an excessive signal strength reaching the end receiver.

It should be noted that the criteria for amplifying or attenuating a particular channel is under a user's control. The controller can be programmed to attenuate or amplify a channel based on the user's needs or what the user perceives to be the system's needs.

If, as will be explained below, multiple other optical network elements are added to the system, these network elements may reduce the signal strength of the channels passing through them. Such a reduction can be compensated for by programming the controller that if a channel passes through a network element (such as optical cross connect or an add/drop multiplexer), then that channel has to be amplified.

Step 240 is that of determining whether the chosen channel needs amplification based on the check in step 230. If so, then the channel is amplified (Step 250). This would involve the controller determining the amount of amplification needed and then commanding the module receiving the channel to amplify the channel. Once this has been done, connector A in FIG. 6 shows that the logic jumps to step 290.

Step 260 is that of determining whether the channel requires attenuation based on the check done in step 230. If so, step 270 details attenuating this channel. This involves the controller calculating the amount of attenuation needed and then commanding the module receiving the channel to attenuate its input. Again, connector A in FIG. 6 shows that the logic jumps to step 290.

If the decisions 240 and 260 are answered in the negative, then the channel's signal strength is to be neither amplified nor attenuated (step 280). This can be done by the controller setting the amplification or attenuation of a channel to zero.

Step 290 is that of checking the output signal to determine whether the signal strength is within the expected range after the channel is attenuated or amplified. Step 300 is that of actually comparing what was detected in step 290 with the desired signal strength. If the output channel is not within acceptable limits, then connector C shows that the logic must return to step 240. This loop ensures that the output is as expected. On the other hand, if the signal is within limits, then connector B shows that the logic returns to step 220, beginning the process anew by selecting another channel.

It should be noted that, while FIG. 3 shows the channel monitor 130 taps the input and output signals before and after the multiplexer and demultiplexer respectively, the monitor may intercept these signals immediately prior to and after the compensation module. This may, however, involve a more complex control mechanism for the monitor than the simple optical switch 140 of FIG. 3.

The monitor 130 necessarily monitors the input and the output as the gain/attenuation provided by the compensation module may vary from module to module. While the module will have a specific range of gain/attenuation: as can be seen from FIG. 5, the performance curve is far from linear. Thus, while it is possible to calculate the amount of pump power required to provide a specific gain/attenuation, it has been found that a searching algorithm executed by the controller works best. By extension, the zero loss/gain point for each module may be different. By constantly monitoring the input and the output of the module (through the compound signal), the gain/attenuation given to a specific channel or channel group can easily be calculated by the controller.

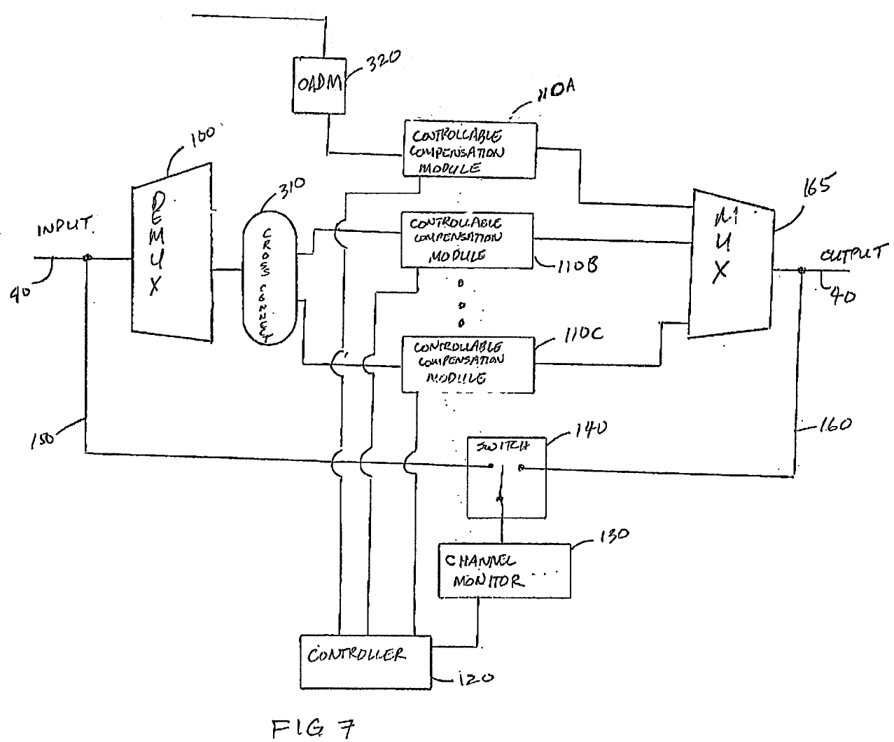

As noted above, the system illustrated in FIG. 3 can contain other network elements. FIG. 7 illustrates such an expanded system. FIG. 7 differs from FIG. 3 in that FIG. 7 incorporates an optical cross connect module 310 and an optical add/drop multiplexer (OADM) 320. As can be seen, the outputs of these two modules 310, 320 are fed into compensation modules 110A, 110B and 110C. The controller 120, knowing that the compensation modules 110A, 110B, 110C are receiving channels from modules which reduce signal strength, can thus command these compensation modules to amplify their respective channels. Alternatively, if the input from these network elements are not desired, the controller can command the compensation modules receiving their channels to attenuate and suppress these channels to a certain degree.

To further explain, if the channel entering the system from the OADM 320 is not desired then the compensation module 110A can be commanded by the controller 120 to attenuate this channel. On the other hand, the output of the cross connect 310 can simultaneously be commanded to be amplified by compensation modules 110B and 110C.

While the input to the OADM 320 originates from outside the system, its signal strength can still be monitored by the monitor 130 through the switch 140. By selecting the channel from the OADM 320 on the output compound signal 40 when the compensation module 110A is set to zero attenuation or zero amplification, the input signal strength of the channel can be detected by the monitor 130. Once this is detected, the controller 120 can adjust it accordingly.

What the invention allows is an unprecedented control over a compound (multi-wavelength) optical signal. The invention “digitizes” a compound optical signal into multiple channel groups and independently controls each of these groups. Thus, if a compound signal carries 40 optical channels, the demultiplexer 100 (see FIG. 3) can demultiplex these 40 channels into any number of groups. For maximum resolution and control, the 40 channels can be demultiplexed into 40 different signals feeding 40 different compensation modules. This allows each of these channels to be individually controlled in terms of amplification and attenuation.

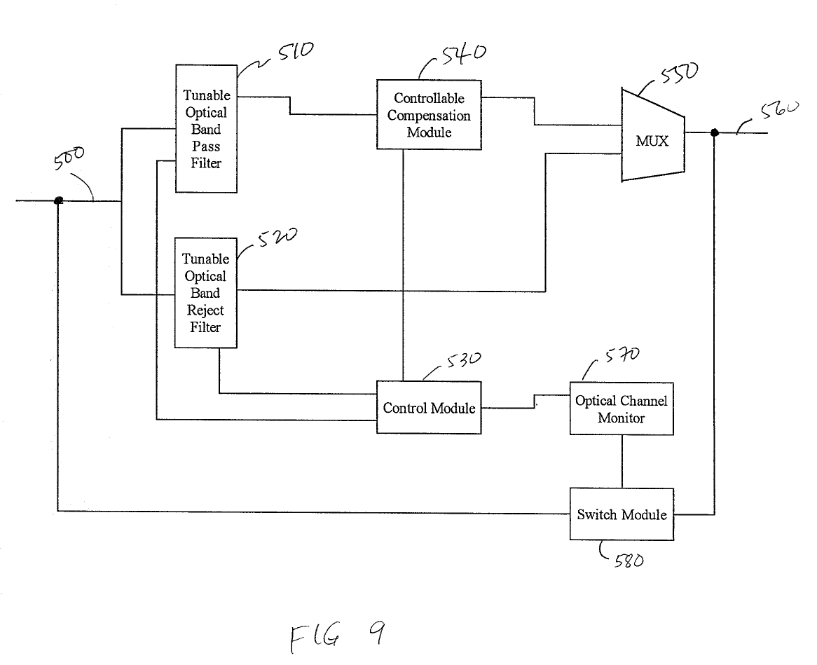

Of course, such resolution requires multiple compensation modules and a 1×40 demultiplexer. For lesser resolution, the 40 channels can be digitized into 8 groups of 5 channels each. Each channel group thus has 5 channels and each of the channel groups can be individually controlled with a compensation module dedicated to each group. As an example, (see FIG. 9 where a full optical spectrum is divided or digitized into groups A-L) if channel group A needs a 2 db gain while groups B and C need a 4 dB attenuation and the rest (groups D-L) need no modification, the software can be commanded to implement this. When the controller examines a group, the compensation module for this group amplifies the group of channels by 2 dB. For groups B and C, the signals are attenuated by 4 dB. The compensation modules for the other channel groups D to L are set to the zero gain point so that they act simply as a pass-through for the channels in groups D to L.

If the user wished to modify only the top and bottom ranges of the spectrum in FIG. 9, then groups A and B and groups I-L can be amplified.

While the above envisions compensation modules which can both attenuate and amplify, a compensation module may be constructed such that it can only amplify or attenuate but not both. If a user does not require attenuation for his system but only amplification, then the compensation module can be constructed thus. The same can be true for a user who only requires attenuation and not amplification.

Based on the above, selected portions of a network's bandwidth can be controlled—Instead of amplifying or attenuating the whole network bandwidth, selected portions can be attenuated or amplified according to need. By properly choosing the channels to be grouped together,. sections of the full bandwidth can be isolated for control.

If, given a full network bandwidth, channels A1, A2, and A3 constitute the high end of the band, channels B1, B2 and B3 constitute the middle range while channels C1, C2 and C3 constitute the low end of the band, proper groupings allow control of selected sections of the band. If A1, A2 and A3 are grouped together, B1, 32 and B3 are grouped together, and C1, C2 and C3 are grouped together, the high low, and middle ranges of the band can be independently controlled. The compensation module serving A1, A2 and A3 can be commanded to amplify these channels while the module receiving C1, C2 and C3 can be similarly commanded. For the module receiving B1, 32 and B3, it may be commanded to attenuate these channels. Thus, in this example, the high and low ends of the bandwidth are amplified while the middle portion is attenuated. Similarly, if the whole bandwidth was to be amplified, then all the groups would have to be amplified. Control over individual channels can be had by, as noted above, increasing the resolution of the system. Further control can be had over group A by feeding the 3 channel group into another demultiplexer which separates the group into individual channels. These individual channels can then be fed into their own compensation modules which will control the strength of the channels.

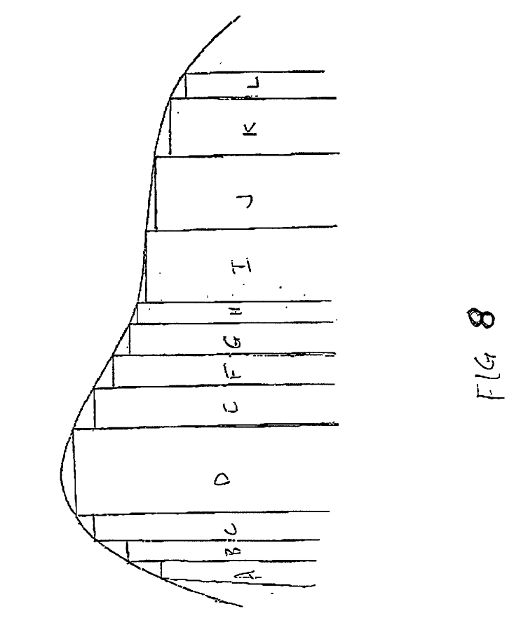

As can be seen in FIG. 8, the bandwidth ranges into which the full spectrum is divided into need not be equal. From FIG. 8, group A occupies a narrower bandwidth range than group D. The bandwidth range of the “digitization” or grouping of channels is within the user's control. By passing the complete spectrum through different bandpass filters, the groupings as illustrated in FIG. 8 can be obtained.

As noted above, channels are grouped and each group can be individually attenuated or amplified as desired. However, for more flexibility, instead of grouping all channels in a bandwidth into different groups, a number of adjacent optical channels can be placed in a single group and attenuation or amplification can be applied only to this group. As an example, referring again to FIG. 8, instead of having a separate controllable compensation module for each of the grouped channels in groups A-L, a single controllable compensation module can be used to only apply signal strength changes to one group at a time.

The above concept can be implemented by, as an example, the system in FIG. 9. As can be seen, an input signal 500 is fed to both a band pass tunable optical filter 520 and a band reject tunable optical filter 520, both of which are coupled to a control module 530. The output of band pass filter 510 is fed to a controllable compensation module 540 which is coupled to the control module 530. The outputs of both the compensation module 540 and of the band reject filter 520 are received by a multiplexer 550 which recombines the two outputs into an overall output signal 560. To help monitor whether the system is functioning properly and to assist the control module 530, a feedback loop in the form of an optical channel strength monitor module 570 and a switch module 580 may be used. The switch module 580 switches the input to the monitor module 570 from either the input signal 500 or the output signal 560. The monitor module 570 is coupled to the control module 530 so that the control module can keep track of both input and output signal strengths of specific optical channels.

In operation, the control module, based on user input or as a programmed response to changing system/network conditions, selects a range of adjacent channels to attenuate/amplify. These channels are then filtered out of the input signal 500 and passed to the compensation module 540 using the band pass filter 570. At the same time, the tunable band reject filter 520 is configured to reject the exact same range of channels which the band pass filter 510 is filtering through. The compensation module 540 is then controlled by control module 530 to either amplify or attenuate the range of grouped optical channels filtered through by the band pass filter 510. The outputs of both the band reject filter 520 and the compensation module 540 are then recombined by the multiplexer 550 to arrive at the overall output signal 560. Thus, the output signal 560 will have all the channels which the input signal 500 originally had, albeit with the signal strength of some channels being changed.

The monitor module 570 and the switch module 580 may be used by the control module 530 to determine if the change in signal strength is working. The signal strength of a specific channel can be monitored prior to the channel being filtered and attenuated/amplified. Then that source channel can be checked at the output 560 to determine if its signal is within the desired limits.

As an alternative to the above system, if the user desires to change the signal strength of all channels received with the exception of a range of adjacent optical channels, the system in FIG. 9 may be altered so that the compensation module 540 is coupled to the output of the band reject filter 520 and the output of the band pass filter 510 is couple directly to the multiplexer 550. With this arrangement, all channels in the input signal, except for the range of adjacent channels filtered by the band pass filter, can be attenuated/amplified by the compensation module 540. Of course, the control module 530 will have to configure the two filters 510, 520 such that the range of optical channels accepted by the band pass filter 510 is the exact range of channels rejected by the band reject filter 520.

While the above system uses band pass and band reject optical filters, the same effect may be obtained by using a demultiplexer as explained above in relation to FIG. 3 and FIG. 7. The method or means for extracting the selected group of channels are myriad and are known to those skilled in the art.

It should be noted that the process for attenuating/amplifying a selected group of adjacent optical channels has the following steps:

First, the range of adjacent optical channels is chosen. This can be done manually or automatically such as in response to an alarm or a changed system condition.

Second, the range of adjacent optical channels selected is isolated from the other optical channels. This step simplifies the attenuation/amplification step and may be accomplished using optical filters and/or optical demultiplexers.

Third, the signal strength of the selected range or group of adjacent optical channels is changed. The signal strength may be attenuated or amplified as desired.

It should be noted that the range or group need not contain multiple optical channels. A single optical channel may be isolated for attenuation/amplification. The system for banded control of optical channels described above may be used at different locations in an optical transmission system. If used at the transmission end, the banded control system would receive several channels multiplexed channels can then be amplified/attenuated separately as explained above. If used at the receiver end of the transmission system, the multiplexed signals can be demultiplexed and separated into different groups, each of which can be separately amplified/attenuated.

It should be clear that use of the above system provides not only independent control of groups of optical channels but also the ability for gain flattening filters. This is especially true if Erbium doped fiber/waveguides are used in the controllable compensation module. Due to the natural gain profile of Erbium, some groups of channels will not need to be amplified as other groups to obtain the same signal strength. If a selected group of channels are in a first region in the natural gain profile which indicates more gain compared to a second region, this group will not need as much amplification as a comparable group located in the second region. Thus, gain equalization is not required as judiciously adjusting the gain/amplification/attenuation for selected groups, based on their location in the natural gain profile, will produce the same signal strength for the whole spectrum. By comparing the resulting signal strength of the selected group of optical channels to the corresponding signal strength of other optical channels, it can be determined how much amplification is needed by the selected group to achieve an approximately uniform or similar signal strength among the optical channels.

As an example, if a specific signal strength is desired for a spectrum of optical channels, one group may need to be amplified by a specific amount to achieve the desired signal strength. On the other hand, a similar group, albeit located in a different region of the natural gain profile of Erbium, may not need as much amplification since this other region may provide more gain than the region in which the first group was located. To better explain, if the waveform in FIG. 8 is taken as the natural gain profile of Erbium, optical channels in group D will need less amplification than optical channels in group J. This is because amplifying group D produces more gain for the signal strength of group D channels than amplifying group J by the same amount. Group J's region in the natural gain profile produces less gain for a specific amount of amplification than group D's region. This concept can also be used for dopants other than Erbium.

A person understanding this invention may now conceive of alternative structures and embodiments or variations of the above all of which are intended to fall within the scope of the invention as defined in the claims that follow.

We claim:

1. A method of controlling a selected group of adjacent optical channels, the method comprising the steps of:
a) selecting a range of adjacent optical channels for inclusion into said group;
b) isolating said selected range of adjacent optical channels from other optical channels;
c) determining an amount by which a signal strength of said selected range of adjacent optical channels is to be changed; and
d) changing said signal strength for said selected range of adjacent optical channels by said amount.

2. A method according to claim 1 wherein said change is an amplification of said signal strength.

3. A method according to claim 1 wherein said change is an attenuation of said signal strength.

4. A method according to claim 1 wherein step b) is accomplished by a device selected form a group comprising:
an optical demultiplexer; and
a tunable filter.

5. A method according to claim 1 wherein step d) is accomplished by a controllable compensation module.

6. A method according to claim 1 wherein said amount is based on corresponding signal strengths of other optical channels.

7. A method according to claim 6 wherein said amount is determined such that a resulting signal strength of said selected group is substantially similar to said corresponding signal strengths of other optical channels.

8. A method according to claim 6 wherein said compensation module comprises:
a pump laser controlled by said control means;
a predetermined length of Erbium doped fiber receiving said selected group, wherein said fiber attenuates the signal strength of said selected group of adjacent optical channels when said pump laser injects an insufficient amount of pump power to one, come absorption of said selected group by said fiber and said fiber amplifies the signal strength of said selected group when said pump laser injects a sufficient amount of pump power to overcome said absorption.

9. A system for controlling a signal strength of a selected group of adjacent optical channels, the system comprising:
isolation means for isolating said adjacent optical channels from other optical channels;
means for changing said signal strength of said adjacent optical channels;
control means for controlling said means for changing said signal strength, wherein
said isolation means routes said adjacent optical channels to said means for changing said signal strength after isolating said adjacent optical channels, and
said control means sends control signals to said means for changing said signal strength to control an amount by which said signal strength of said adjacent optical channels is changed.

10. A system according to claim 9 wherein said isolation means is selected from a group comprising:
a tunable optical filter; and
an optical demultiplexer.

11. A system according to claim 9 wherein said means for changing said signal strength is a controllable compensation module receiving said selected group of adjacent optical channels.

12. A system according to claim 11 wherein sad controllable compensation module comprises:
a pump laser controlled by said control means;
a predetermined length of doped fiber receiving said selected group, wherein said fiber attenuates the signal strength of said selected group of adjacent optical channels when said pump laser injects an insufficient amount of pump power to one, come absorption of said selected group by said fiber and said fiber amplifies the signal strength of said selected group when said pump laser injects a sufficient amount of pump power to overcome said absorption.

13. A system according to claim 8 wherein said tunable optical filter is controlled by said control means.

14. A system according to claim 9 wherein said amount is based on corresponding signal strengths of other optical channels.

15. A system according to claim 14 wherein said amount is determined such that a resulting signal strength of said selected group is substantially similar to said corresponding signal strengths of other optical channels.

16. A method of controlling a selected group of adjacent optical channels, the method comprising the steps of:
a) selecting a range of adjacent optical channels for inclusion into said group;
b) isolating said selected range of adjacent optical channels from other optical channels;
c) determining an amount by which a signal strength of said selected range of adjacent optical channels is to be changed; and
d) changing said signal strength for said selected range of adjacent optical channels by said amount such that said signal strength is substantially similar to corresponding signal strengths of other optical channels.
